(19) United States
(12) Patent Application Publication
(10) Pub. No.: US 2010/0069236 A1
(43) Pub. Date: Mar. 18, 2010

(54) METHODS FOR MANFACTURING LI-DOPED SILICA NANOTUBE USING ANODIC ALUMINUM OXIDE TEMPLATE AND USE OF THE LI-DOPED SILICA NANOTUBE FOR ENERGY STORAGE

(76) Inventor: Hae Jin Kim, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/312,227

(22) PCT Filed: Oct. 11, 2007
(86) PCT No.: PCT/KR2007/004971

§ 371 Date: Apr. 30, 2009

(30) Foreign Application Priority Data
Nov. 10, 2006 (KR) 10-2006-0110941

(51) Int. Cl. B01J 20/04

(52) U.S. Cl. 502/405

(57) ABSTRACT

Disclosed herein are a method of preparing Li-doped silica nanotubes using an anodic aluminum oxide (AAO) template, and a method of storing energy using the prepared Li-doped silica nanotubes. Unlike prior methods for preparing metal nanotubes, according to the disclosed preparation method, the Li-doped silica nanotubes having a uniform size can be easily obtained in mild conditions using a lithium precursor, a silica sol and an anodic aluminum oxide template. The preparation method comprises adsorbing the lithium precursor and the silica sol on the surface of the AAO template, drying the lithium precursor and the silica sol, adsorbed onto the AAO template, in a vacuum, to form nanotubes, and then drying the nanotubes. The Li-doped silica nanotubes prepared according to the disclosed method can be used as economical hydrogen storage materials, electrode materials for lithium secondary batteries, or energy storage sources for automobiles or other transportation means.

Methods for manufacturing Li-doped silica nanotube using anodic aluminum oxide template and use of the Li-doped silica nanotube for energy storage

### TECHNICAL FIELD

The present invention relates to a method of preparing L-doped silica nanotubes in an economic and efficient manner using a lithium precursor, a silica sol and an anodic aluminum oxide template (AAO), and to the use of the prepared Li-doped silica nanotubes for energy storage.

### BACKGROUND ART

There have been many attempts to synthesize nano-structures using anodic aluminum oxide (hereinafter, abbreviated as “AAO”) templates, including the synthesis of carbon nanotubes on AAO templates by chemical vapor deposition, the formation of sodium nanotubes on the inner wall of AAO templates, and the synthesis of LiMn₂O₄ nanowires using AAO templates.

Generally, one of the advantages of the methods of fabricating (synthesizing) nano-structures using AAO templates is that the fabricated nano-structures are in the form of straight and uniform cylinders and are highly dense. The AAO templates do not participate in a reaction for producing nanotubes/nanorods, but have many effects on the physical configuration of the nano-structures.

The nano-structures can be used in various applications in various fields, and the typical use thereof is a role as energy storage materials for storing hydrogen.

Hydrogen is infinite clean energy, because it can be obtained from water on the earth and is recycled to water after it is burned. Thus, because hydrogen (energy) is clean energy does not generate any pollutant substance other than water when it is burned, it can be used in almost all fields, such as various transportation means or power generation systems.

However, one problem in the use of such hydrogen energy is that a convenient, economical and safe hydrogen storage system has not yet been developed.

One of conventional hydrogen storage methods is a physical method in which hydrogen is compressed and stored in a high-pressure container at 100 atm or more, but it is very risky in terms of safety to mount and use this high-pressure container in transportation means. Another physical method for storing hydrogen is a method in which hydrogen is stored at a cryogenic temperature lower than the boiling point (20.3 K) thereof. This method has an advantage in that it can significantly reduce the storage volume of hydrogen so as to store an increased amount of hydrogen can be stored, but it is very disadvantageous in terms of economy, because an auxiliary unit (freezing unit) for maintaining hydrogen at a cryogenic temperature is required.

Meanwhile, a chemical storage method, which uses a hydrogen storage alloy, has an advantage in that hydrogen storage efficiency is high, but there are problems in that, when the storage and release of hydrogen are repeatedly performed, the hydrogen storage alloy is modified due to impurities in hydrogen, and thus the hydrogen storage capacity is reduced with the passage of time. In addition, it has a disadvantage in that, because the alloy is used as a hydrogen storage medium, the weight per unit volume is increased, and thus it is not easy to mount and use the alloy in transportation means.

Still another method for storing hydrogen is a method in which hydrogen is stored by adsorbing gaseous hydrogen onto a solid material. According to various reports on the efficiencies of methods of storing hydrogen using carbon nanotubes or carbon structures, among such adsorption methods, hydrogen storage efficiencies much higher than 10 wt % have been reported. However, such results lack reproducibility, and thus many studies are still in progress.

Accordingly, in order to develop a hydrogen storage method, which achieves a hydrogen storage target of 6.5 wt % set by the US Department of Energy (DOE), eliminates various problems as mentioned above and ensures stability and economic efficiency, many studies are currently in progress.

Typical fields, in which surface chemistry control at the nano level, may include lithium ion secondary batteries. The lithium ion secondary battery has relatively light weight and high energy conversion efficiency compared to those of other batteries, and thus is widely used as a power source in portable, small-sized electronic devices. Since a lithium secondary battery, comprising graphite as a negative electrode material and LiCoO₂ as a positive electrode material, was first put on the market by Sony Corp in the year 1991, many groups throughout the world have conducted competitive studies in order to develop electrode materials having more excellent performance. As the use of small-sized electronic products becomes popular, the scale of the world market for lithium secondary batteries as power sources also increases annually by more than 30%. Since the lithium ion battery, comprising LiCoO₂ and carbon material as positive electrode material and negative electrode material, respectively, was commercialized, the lithium ion battery has became one of secondary batteries, which are currently most widely used.

One of the most important components of the lithium ion secondary battery is a positive electrode, and more than 60% of research papers on the lithium ion secondary battery relate to the synthesis and reaction of the positive electrode material. Positive electrode materials, which are currently most widely used, are composite metal oxides, such as Li (Co,Ni,Mn)O₂ having a layered structure, or LiMn₂O₄ having a spinel structure.

In the lithium ion secondary battery, the charge/discharge capacity of the positive electrode varies depending on the particle size and particle structure of the positive electrode material. That is, as the particle size of the positive electrode material becomes smaller, the diffusion of lithium ions becomes faster, and thus the charge/discharge capacity of the positive electrode can be increased. Also, even when the positive electrode material has a particle structure in which the diffusion of lithium ions easily occurs, the charge/discharge capacity of the positive electrode itself can be increased. Moreover, because the stability of the crystal structure has a close connection with reversibility, it is closely connected with the cycle life of the battery. Accordingly, the preparation of powder, having foreign matter and having excellent crystallinity, is a key technology that determines battery performance.

However, prior methods for preparing composite metal oxides have shortcomings in that they include several complex steps and require much equipment and time. Also, in the prior methods for synthesizing composite metal oxides, the synthesis process is carried out at high temperatures, the particle size of reactants is relatively large, it is difficult to control the physical properties (e.g., shape or surface characteristics) of produced particles, and limited starting materials such as oxides should be used. Accordingly, if a pure compound, having the shape of lithium-doped nanotubes, can be obtained through a simple preparation method, it can be used as a positive electrode material for lithium secondary batteries.

### DISCLOSURE

### Technical Problem

It is an object of the present invention to provide a method which enables Li-doped silica nanotubes, having uniform nanosized pores, to be efficiently prepared in mild conditions using a lithium precursor-containing silica sol and an anodic aluminum oxide template.

Another object of the present invention is to use the Li-doped silica nanotubes, prepared according to said preparation method, to provide an economical hydrogen storage method, which shows high storage efficiency, is safe and has good reproducibility, compared to the prior hydrogen storage methods.

### Technical Solution

To achieve the above objects, the present invention provides a method for preparing L-doped silica nanotubes, the method comprising: an immersion step of immersing an anodic aluminum oxide (AAO) template in a lithium precursor-containing silica sol solution so as to adsorb the lithium precursor and the silica sol onto the AAO template; a vacuum drying step of separating the AAO template, adsorbed with the lithium precursor and the silica sol, from the solution, and drying the separated AAO template in a vacuum, so as to remove portions other than the lithium precursor and silica sol adsorbed onto the AAO template; an oxidation step of thermally treating the AAO template, adsorbed with the dried lithium precursor and silica gel, in the presence of oxygen, so as to oxidize the lithium precursor and silica gel adsorbed on the surface of the AAO template; a dissolution process of immersing the AAO template, adsorbed with the oxidized lithium precursor and silica gel, in an aqueous NaOH or KOH solution, so as to dissolve only the AAO template; a filtering step of performing solid-liquid separation between the AAO solution and solid Li-doped silica nanotubes, produced in the dissolution step; a drying step of drying the Li-doped silica nanotubes separated from the AAO solution; and a calcining step of calcining the dried, Li-doped silica nanotubes.

In the present invention, the silica sol solution can be prepared by polymerizing a silica precursor in alcohol and/or water with stirring. Hydrochloric acid acts as a catalyst in said reaction, and thus, when it is added to the reaction solution, it enables the silica sol solution to be prepared in a shorter time. The silica precursor may be, for example, tetraalkoxysilane, in which the alkoxy group is preferably a straight- or branched-chain C1-C5 alkoxy group. Also, the silica precursor is not limited to tetraalkoxysilane, and any silica precursor may be used in the present invention, as long as it can be adsorbed onto the AAO template and can form silica (silicon dioxide) in the drying and oxidation steps.

In Examples of the present invention, LiNO₃ was used as the lithium precursor, but the scope of the present invention is not limited thereto. Any lithium precursor may be used in the present invention, as long as it can be adsorbed onto the AAO template, can form lithium oxide in the drying step and can be dissolved in distilled water. That is, it will be obvious to those skilled in the art that other lithium salts, such as lithium hydroxide, halide, nitrate, carbonate or sulfate, may also be used in the preparation of the Li-doped silica nanotubes. The molar ratio of the silicon precursor to the lithium precursor is preferably 1: 1-10. More preferably, the lithium precursor is added to the silicon precursor at a molar ratio of 1: 1-3.

According to the embodiment of the present invention, unlike the prior processes for preparing nanotubes, the Li-doped silica nanotubes having uniform nanosized pores can be synthesized in mild conditions.

Also, the AAO template preferably has a pore size of 180-250 nm and a thickness of 40-80 μm. When an AAO template having an average pore size of less than 180 nm was used, nanotubes were not correctly formed. On the other hand, an AAO template having a pore size of more than 250 nm is not useful, because the pore size is too large to form nanostructures, particularly for use as energy storage materials.

In the dipping step, the amount of use of the Li-doped silica sol is determined depending on the size of the AAO template, because the Li-doped silica sol should be used in an amount that can sufficiently wet the AAO template. When the AAO template is not sufficiently wetted, the non-wetted portion is not adsorbed with the Li-doped silica sol, and thus the Li-doped silica sol should be used in an amount sufficient for completely wetting the AAO template. The Li-doped silica sol may also be used in excess, because the amount of the silica sol, which remains after adsorption, is removed during the filtering step. However, because this causes a great loss in terms of economy, it is preferable to use the silica sol in a suitable amount in view of the size of the AAO template. The dipping process is preferably carried out at room temperature for 1-5 hours.

The vacuum drying step is preferably carried out at a temperature of 40-80 t for 2-5 hours. If the drying temperature is excessively low or if the drying time is excessively short, sufficient drying is not achieved. In order to enable the Li-doped silica nanotubes to be prepared, water remaining on the AAO template should be dried in a vacuum before the oxidation step. In Examples of the present invention, water was not sufficiently dried in a vacuum, the nanotubes were not formed. In the vacuum drying step, high drying temperature or long drying time do not influence the preparation of the carbon nanotubes, but has the problem of reducing the drying efficiency.

The oxidation step for oxidizing the Li-doped silica gel is preferably carried out in the presence of oxygen at 80-150° C. for 1-4 hours, such that the adsorbed, Li-doped silica gel can be sufficiently oxidized. As used herein, the term “presence of oxygen” refers to the presence of oxygen which reacts with the silicon precursor during thermal treatment. Thus, the thermal treatment may also be carried out using oxygen gas, filled in a dryer for the supply of oxygen, but in this case, there is an economic burden. For this reason, the thermal treatment may also be simply carried out in the presence of air.

The aqueous NaOH or KOH solution, which is used in the dissolution step, is preferably a 1-5M aqueous solution. Also, the aqueous solution is preferably used in an amount of more than 50 ml per 0.174 g of the AAO template, such that it can sufficiently dissolve the AAO template.

The AAO template, dissolved through the dissolution step, is separated through the filtering step from the Li-doped-silica nanotubes, which remain in the solid state. In the filtering step, the nanotubes are sufficiently washed with purified water, such that the NaOH or KOH solution containing the AAO template dissolved therein does not remain on the nanotubes.

The Li-doped silica nanotubes, obtained through the filtering step, contain a small amount of water. In order to remove the remaining water, the carbon nanotubes are dried at a temperature of 80-150° C. for 1-4 hours. After drying, the nanotubes are calcined at a temperature of 450-550° C. for 2-3 hours. Through this drying and calcining step, the remaining water and impurities can be more efficiently removed.

The Li-doped silica nanotubes according to the present invention can be applied as energy storage materials, that is, lithium secondary battery materials and hydrogen storage materials capable of storing hydrogen. Particularly, it could be found that the inventive Li-doped silica nanotubes showed a hydrogen storage capability, which was about 2.5 times higher than that of Li-undoped silica nanotubes, suggesting that the doping of lithium had a significant effect on the improvement in hydrogen storage capability.

### Advantageous Effects

According to the present invention, Li-doped silica nanotubes having a uniform size can be prepared in mild conditions only using a lithium precursor, a silica sol and an AAO template.

Also, the Li-doped silica nanotubes obtained according to the inventive preparation method have a relatively large specific surface area, and thus can store a large amount of hydrogen in a relatively small volume and can safely transport the stored hydrogen.

### DESCRIPTION OF DRAWINGS

FIG. 1 is an SEM photograph of Li-doped silica nanotubes according to Example of the present invention.

FIG. 2 is a TEM photograph of Li-doped silica nanotubes according to Example of the present invention.

FIG. 3 is an SEM photograph of silica nanotubes according to Comparative Example of the present invention.

FIG. 4 is a graphic diagram showing the X-ray diffraction of silica nanotubes according to Comparative Example of the present invention.

FIG. 5 is a photograph showing a RUBOTHERM system for measuring the hydrogen storage capability of Li-doped silica nanotubes, prepared according to the present invention.

FIG. 6 is a graphic diagram showing the hydrogen adsorption capability of silica nanotubes according to Comparative Example of the present invention.

FIG. 7 is a graphic diagram showing the hydrogen adsorption capability of Li-doped silica nanotubes according to Examples of the present invention.

### BEST MODE

Hereinafter, the construction, operation and effect of the present invention will be described in further with reference to the accompanying drawings and the following examples. It is to be understood, however, that these examples are illustrative only, and the scope of the present invention is not limited thereto.

### EXAMPLES

### Example 1

### Preparation of Li-doped Silica Nanotubes

First, 23 g of tetraethoxysilane (TEOS, Aldrich), 5 g of ethanol (Merck), 5.9 g of distilled water and 2.2 g of 0.1 M HCl (Aldrich) were mixed with each other, and the mixture was allowed to react with intensive stirring at a temperature of about 70° C. for 5 min. As the reaction was completed, the unclear silica mixture solution became clear due to the formation of silica sol. To the silica sol, a lithium precursor solution obtained by dissolving 3.1 g of LiNO₃

(Aldrich, 99.9%) in 10 mL of ethanol was added, thus preparing a Li-doped silica sol.

In the Li-doped silica sol, 4.35 g of an AAO (Anodisc 47, Whatman) template was immersed for 2 hours. The main component of the Anodisc 47 was anodisc alumium oxide (AAO), and the important physical properties thereof are shown in Table 1. Then, the AAO template was separated from the solution, and was dried in a vacuum dryer at 40° C. for 4 hours in order to remove the Li-doped silica sol which was not adsorbed onto the AAO template. The dried AAO template was dried in an air atmosphere at 100° C. for 2 hours so as to be sufficiently oxidized. In order to obtain only the Li-doped silica nanotubes from the dried AAO template, the AAO template was immersed in 1M NaOH solution for 3 hours, and then the alumina membrane dissolved in the NaOH solution was washed several times with distilled water. The Li-doped silica nanotubes resulting from the filtering step was dried in a dyer at 100° C. for 3 hours, and the dried Li-doped silica nanotubes were calcined in an electric furnace in an air atmosphere at 500° C., thus preparing Li-doped silica nanotubes, the wall thickness of which was about 50 nm.

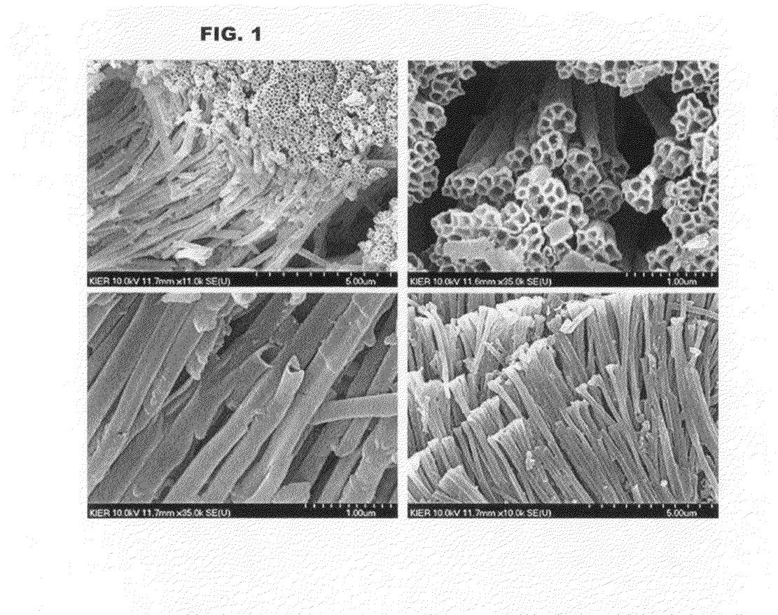

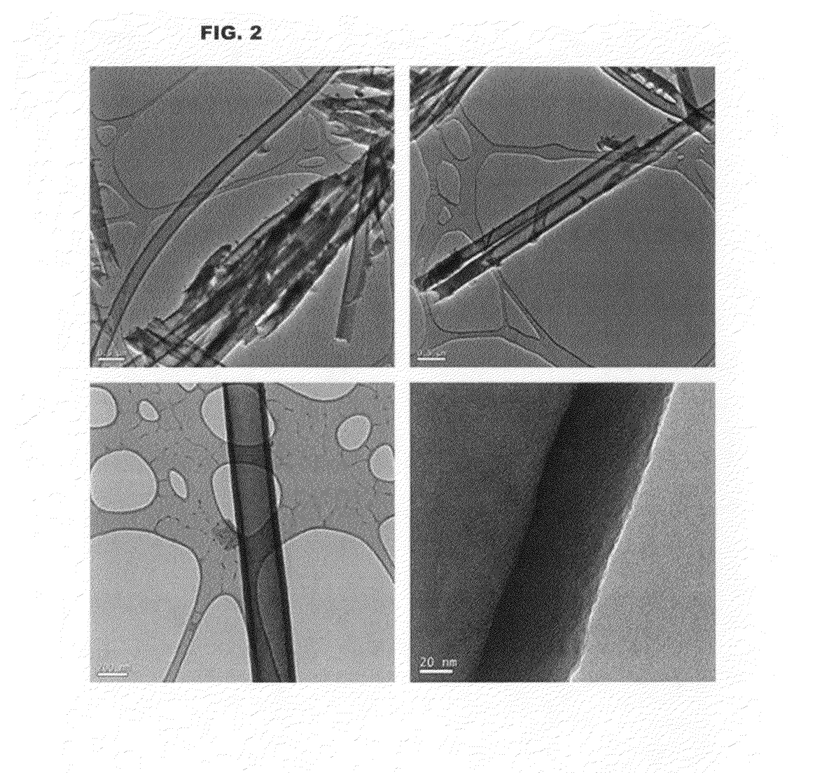

FIGS. 1 and 2 show an SEM (scanning electron microscopy) photograph and TEM (transmission electron microscopy) photograph of the Li-doped silica nanotubes prepared according to the method of this Example. As can be seen in the photographs, the Li-doped silica nanotubes, prepared in Example 1, have a uniform size with a tube wall thickness of about 50 nm and have a very large surface area, suggesting that they are highly advantageous for the storage of hydrogen.

### Comparative Example

### Preparation of Silica Nanotubes Only Using Silica Sol

Silica nanotubes were prepared according to the same method as Example 1, except that LiCl₃ was not added to the silica sol.

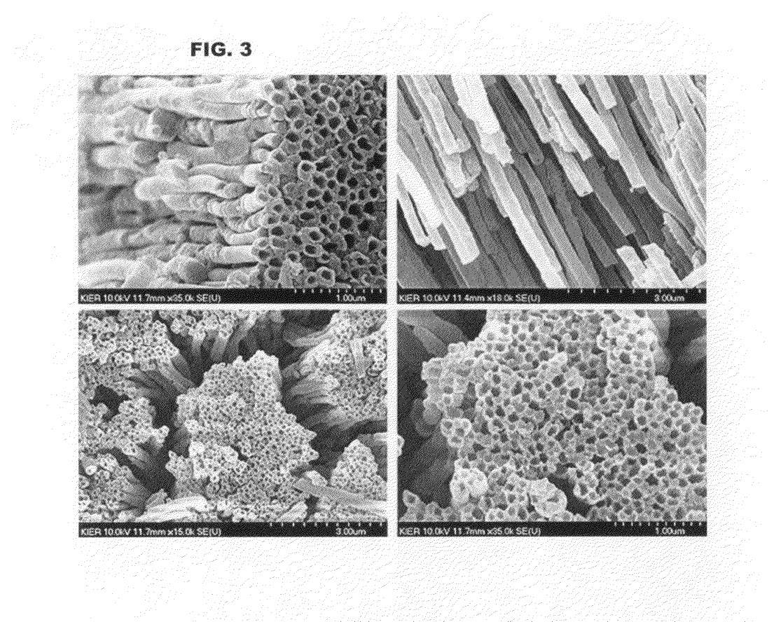

FIG. 3 shows an SEM photograph of silica nanotubes prepared according to the method of this Comparative Example. As can be seen in FIG. 3, the silica nanotubes prepared in this Comparative Example have a uniform size with a tube wall thickness of about 50 nm and are uniformly arranged in a given direction.

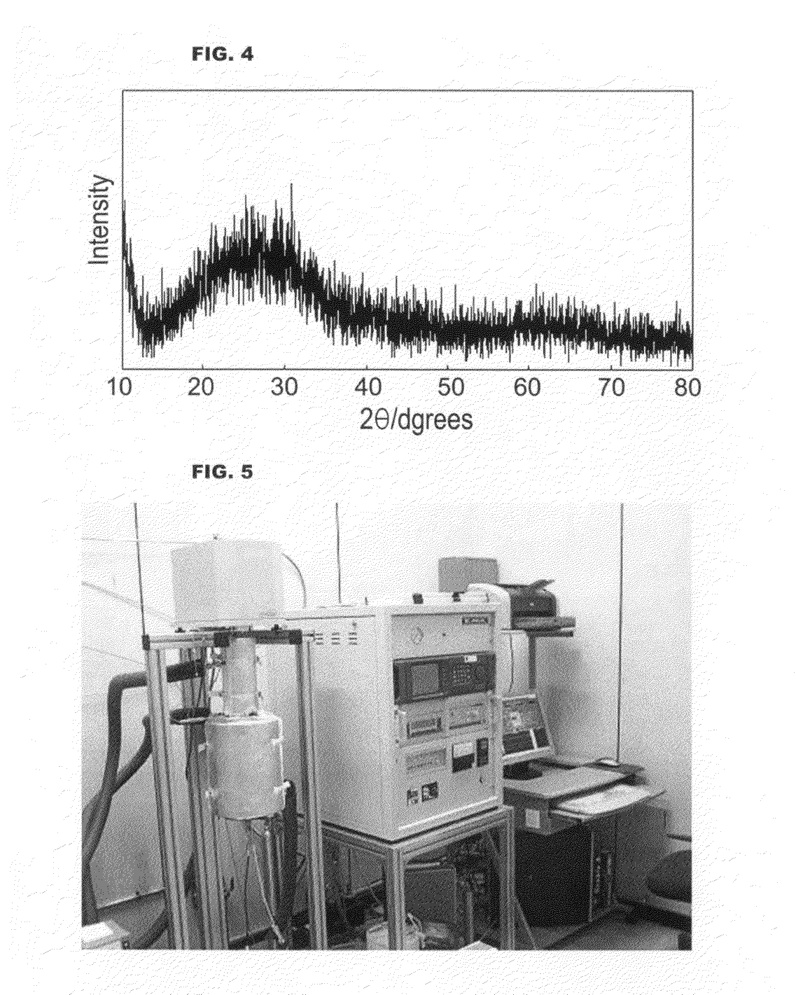

FIG. 4 shows an X-ray diffraction graph of silica nanotubes calcined at 500° C. As can be seen in FIG. 4, only one wide peak was observed at about 20-35°. This suggests that the silica nanotubes have an amorphous structure.

### Example 2

### Measurement of Hydrogen Storage Capability of Nanotubes

The silica nanotubes, prepared in Comparative Example, and the Li-doped silica nanotubes, prepared in Example 1, were measured for hydrogen storage capabilities in the following manner. As shown in FIG. 5, the RUBOTHERM system (analytical balance, magnetic coupling and adsorption chamber) was used to perform adsorption isotherm measurements at high pressure (135 bar) and high temperature (525 K).

The samples to be measured for hydrogen storage capabilities were kept in a vacuum at a temperature of 298 K and a pressure of 10⁻³ Pa for 12 hours in order to remove foreign matter from the samples.

When a new sample has been introduced, its volume must be determined to perform the buoyancy effect correction. This volume was measured by blowing inert gas (helium or nitrogen) onto the sample.

The hydrogen adsorption kinetic measurement procedure was quite simple. After a small amount of hydrogen was admitted in the adsorption chamber, an equilibrium test was performed on mass and pressure. This pressure and temperature were stored in real time in a data file in a computer connected with the hydrogen storage measurement system. The data were corrected to take in account the buoyancy effect.

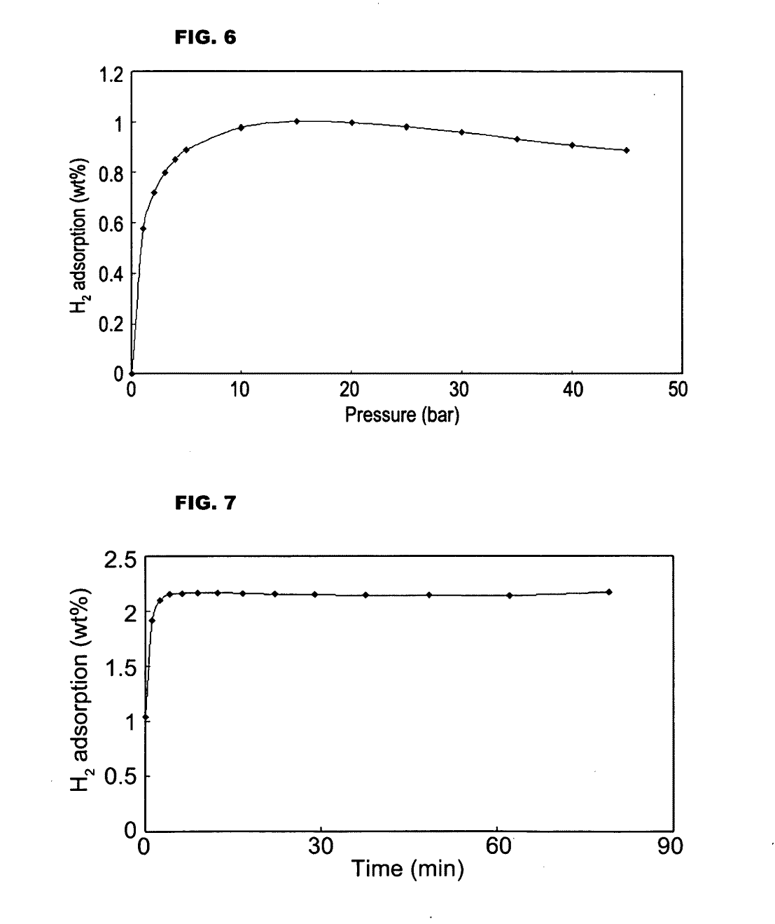

In the case of the silica nanotubes, the hydrogen adsorption was measured at 77K under varying pressures, and the measurement results are shown in FIG. 6. In the case of the Li-doped silica nanotubes, the hydrogen adsorption was measured at 77K under 45 bar at varying points of time, and the measurement results are shown in FIG. 7.

As can be seen in FIG. 6, the silica nanotubes showed a hydrogen adsorption of 1.0 wt % or less at 77K and 15 bar, a hydrogen adsorption of about 0.88 wt % at 45 bar.

However, as shown in FIG. 6, the Li-doped silica nanotubes shows a hydrogen adsorption of about 2.16 wt % at 77K and 45 bar, suggesting that the hydrogen storage capability was increased by two times or more, compared to that of the Li-undoped silica nanotubes. Also, it could be observed that the hydrogen saturation reached saturation 2 minutes after hydrogen gas was introduced into the chamber containing the Li-doped silica nanotubes.

### INDUSTRIAL APPLICABILITY

As described above, according to the present invention, Li-doped silica nanotubes having a uniform size can be prepared in mild conditions only using a lithium precursor, a silica sol and an AAO template.

Also, the Li-doped silica nanotubes according to the present invention can be applied as energy storage materials, that is, lithium secondary battery materials, and hydrogen storage materials capable of storing hydrogen. Particularly, it can be found that the Li-doped silica nanotubes of the present invention show a hydrogen storage capability, which is about 2.5 times higher than that of Li-undoped silica nanotubes, suggesting that the doping of lithium has a significant effect on the improvement in hydrogen storage capability.

1. A method for preparing Li-doped silica nanotubes, the method comprising:
immersing an anodic aluminum oxide (AAO) template in a lithium precursor-containing silica sol solution so as to adsorb the lithium precursor and the silica sol onto the AAO template;
separating the AAO template, adsorbed with the lithium precursor and the silica sol, from the solution, and drying the separated AAO template in a vacuum, so as to remove portions other than the lithium precursor and silica sol adsorbed onto the AAO template;
thermally treating the AAO template, adsorbed with the dried lithium precursor and silica gel, in the presence of oxygen, so as to oxidize the lithium precursor and silica gel adsorbed on the surface of the AAO template;
immersing the AAO template, adsorbed with the oxidized lithium precursor and silica gel, in an aqueous NaOH or KOH solution, so as to dissolve only the AAO template;
performing solid-liquid separation between the AAO solution and solid Li-doped silica nanotubes, produced in the dissolution step;
drying the Li-doped silica nanotubes separated from the AAO solution; and
calcining the dried, Li-doped silica nanotubes.

2. The method of claim 1, wherein the lithium precursor is at least one salt selected from the group consisting of lithium hydroxide, halide, nitrate, carbonate and sulfate.

3. The method of claim 1, wherein the anodic aluminum oxide (AAO) template has a pore size of 180-250 nm and a thickness of 40-80 μm.

4. The method of claim 1, wherein the vacuum drying step is carried out at a temperature of 40-80° C. for 2-5 hours.

5. Use of the Li-doped silica nanotubes, prepared according to claim 1, for hydrogen storage.

6. Use of the Li-doped silica nanotubes, prepared according to claim 2, for hydrogen storage.

7. Use of the Li-doped silica nanotubes, prepared according to claim 3, for hydrogen storage.

8. Use of the Li-doped silica nanotubes, prepared according to claim 4, for hydrogen storage.
